(19) United States
(12) Patent Application Publication
(10) Pub. No.: US 2016/0341585 A1
(43) Pub. Date: Nov. 24, 2016

(54) Multiphase Flow Meter

(71) Applicant: Medeng Research Institute Ltd., Calgary (CA)

(72) Inventor: Willow Zhu Liu, Calgary, CA (US)

(21) Appl. No.: 14/716,323

(22) Filed: May 19, 2015

(51) Int. Cl. G01F 1/74; G01F 1/34

(52) U.S. Cl. CPC G01F 1/74; G01F 1/34

(57) ABSTRACT

A multiphase flowmeter, and a method of analyzing and measuring multiphase flow is described. The multiphase flowmeter includes a combination 3 flow elements where a pressure differential is measured. The disclosed multiphase flowmeter relies on pressure differential measurements, however it does not rely on a specific method of generating these measureable pressure differentials in each of the flow elements. The pressure differentials can be caused by a variety of means such as a flow obstruction within the flow element. The meter also has a pressure transmitter which measures the in-pipe pressure and a temperature sensor which measures the fluids' temperature. From the signals obtained from the above sensors, an overall analysis of the multiphase fluid flow is performed providing a complete set of flow measurement data for a fluid mixture composed of 3 phases, which 3 phases may be oil, water and gas, or in the case of a wet gas application, gas, gas condensate and water.

### FIELD

The present disclosure relates generally to an apparatus and method of analysis for the measurement of a multiphase fluid flow. The disclosure is particularly, but not exclusively, suitable for measuring the flow of multiphase fluids that are produced in oil and gas wells, on shore and off shore installations, pipe lines and in refineries.

### BACKGROUND

The oil and gas industry is increasingly calling for a multiphase flow metering technology that is compact, lightweight and most importantly affordable, which can be installed “in-line” and produce a complete set of accurate measurements on each component of a multiphase flow.

Various devices are used in the industry, however none is considered capable of meeting satisfactorily all the requirements that are posed by wide ranging set of field conditions in the industry. No single device handles the many flow and fluid conditions that are encountered due to both geological conditions and industrial methods of extraction, and/or meets the precision requirements over the full extent of the large range of flow rates, water cut, and gas fraction that occur in the field. As a result, the devices that exist tend to find niche applications only, or they require complex data inputs or be combined with other equipment and devices in order to fully service the flow measurements of multiphase fluids. In addition, several devices make use of radioactive sources, which hold significant disadvantages. The use of these sources imposes careful and important containment requirements to mitigate the possibility of contamination, and as a result the industry is reluctant to fully accept methods making use of radioisotopes.

Commercialized MPFMs (multiphase flowmeters) can roughly be divided into two categories:

The first category is based on a pre-requisite step of separation of the liquid and gas phases. Once the liquid and gas phases are separated, the flow measurements are conducted upon the liquid phase and the gas phase separately. The principles of such a method are simple and well known at large and relatively good precision in measurement is generally achieved when the separation is successfully performed. This category of MPFM has been widely accepted in the oil industry worldwide. One example is U.S. Pat. No. 6,338,276. The separation of liquid and gas phases are usually achieved using gravity or centrifugal forces. The equipment, called separators, is generally large, difficult to install and relatively costly. The degree of precision/imprecision of the measurements is directly affected by the efficiency of the separation process and compounded by the inherent precision/imprecision of the individual and separate measurements of the liquid and gas phases that are performed after the separation. Room for improvement of the achievable precision inherent to this method is therefore limited. In addition measurements are neither performed in-line or on a real-time.

The second category of MPFMs does not require any fluid pre-separation. It measures directly the various parameters of the multiphase flow. It generally uses an orifice or venturi flowmeter for flow rate measurement. For the measurement of phase fractions (i.e. watercut, GVF and GOR) it also uses a number of technologies such as gamma radioisotopes, microwaves, tomography or capacitance/impedance. Generally this method can perform inline real-time measurements of multiphase flow with an acceptable level of precision/imprecision, and it has achieved a degree of acceptance by the industry. An example of this category of device is provided by the Framo Phase Watch VX and U.S. Pat. No. 6,935,189.

Another example of a multiphase flowmeter in this category is U.S. Pat. No. 7,963,172, by Liu and Liu, titled Multiphase Flowmeter Using a Combination of Pressure Differentials and Ultrasound Doppler Readings which uses two pressure differentials caused by orifice plates in combination with an ultrasound Doppler sensor.

It is, therefore, desirable to provide an improved multiphase flowmeter.

### SUMMARY

A multiphase flowmeter, and a method of analyzing and measuring multiphase flow is described. The multiphase flowmeter includes a combination of 2 or 3 flow elements where a pressure differential is measured. The disclosed multiphase flowmeter relies on pressure differential measurements, however it does not rely on a specific method of generating these measureable pressure differentials in each of the flow elements.

The pressure differentials can be caused by a variety of means such as a flow obstruction within the flow element (i.e. orifice, Venturi, etc.) or be caused by either the drag of the fluids flowing through a straight length of pipe without any obstruction or by gravity in a vertical straight length of pipe, also without any obstructions.

A flowmeter may use one of these methods of causing a pressure differential in each of its flow elements or use a combination of them in the same flowmeter.

The meter also has a pressure transmitter which measures the in-pipe pressure and a temperature sensor which measures the fluids' temperature. From the signals obtained from the above sensors, an overall analysis of the multiphase fluid flow is performed providing a complete set of flow measurement data for a fluid mixture composed of 3 phases, which 3 phases may be oil, water and gas, or in the case of a wet gas application, gas, gas condensate and water. The disclosed multiphase meter and method provides measurement of any multiphase fluids composed of 3 distinct phases. However, the disclosed multiphase meter is also suitable for two-phase or even in a single-phase situation.

By performing a complete analysis of the multiphase fluid on the basis of the pressure, pressure differential and/or ultrasound sensors within the device, this disclosure solves the problems associated with radioactive sources and with the need to make use of combined technologies. It also eliminates the need for PVT data inputs.

The technology presented here is therefore different with other existing and published technologies and methods. The following aspects, either individually or combined, constitute this differentiation:

The present disclosure does not require any pre-conditioning of the multiphase flow, such as pre-separation of the gas and fluid and/or mixing.

The present disclosure does not make use of upstream or downstream devices to measure water fraction or perform separately other two-phase in well measurements such as gas-oil ratio. In other words it is self-sufficient in the sense that it analyses and measures multiphase flow completely from direct readings performed by the device's sensors.

The present disclosure does not make use of any radioactive sources.

The present disclosure does not make use of any imaging (computational tomography) device.

The present disclosure does not make use of PVT information as input data.

The present disclosure measures the individual phase flow rates of the dead liquids directly, hence does not require that measured live liquids rates containing solution gas be converted.

The present disclosure measures the total gas component directly, including gas that is both free gas and gas that is in solution with the liquids.

The present disclosure is simple, accurate with measurement stability and repeatability.

First the pressure differentials measurements performed by sensors located at the flow elements are obtained from the transmitters. The pressure differentials may be caused by a variety of means, including obstructions such as orifice, venture, etc. and/or with no obstructions but the fluid drag across a straight length of pipe. The present disclosure can be configured with 3 flow elements in sequence to obtain volumetric flowrates of the mixture.

A pressure and temperature sensor are added along the length of the instrument. The data produced by these sensors is communicated on a real-time basis to the microcomputer that calculates the total mass flowrates, total mixture densities and liquids only densities. In turn, the watercut and the flowrates of the gas, water and oil phases are derived. The in-pipe gas flowrate is then converted to a gas flowrate under standard atmospheric pressure.

The disclosed multiphase flow meter and methods provide the measurements of volume and mass flowrates and respective cumulative for each individual phase of oil, water and gas, and for the total mixture, as well as the watercut and the gas-liquid ratio.

It is an object of the present disclosure to obviate or mitigate at least one disadvantage of previous multiphase flow meters.

In a first aspect, the present disclosure provides a multiphase flowmeter for measuring the flow of a multiphase fluid through an in-line conduit including three differential pressure flow elements disposed in the conduit, two at locations near the extremities of a uniform flow pipe, and the third across the other two, where three pressure differentials dp₁, dp₂, and dp₃ are measured with three differential pressure sensors, a pressure P sensor, and a temperature T sensor.

In an embodiment disclosed, the multiphase flowmeter includes a flow computer for computing one or more flow parameters of the multiphase fluid from pressure differentials dp₁, dp₂, dp₃, and pressure P and temperature T sensors.

In an embodiment disclosed, the three pressure differentials dp₁, dp₂, dp₃, the pressure P sensor, and the temperature T sensor are disposed over a plurality of tubular members or in different order or locations.

In an embodiment disclosed, the differential pressure flow elements are selected from the group including but not limited to an orifice plate, a Venturi, the friction resistance of a straight length of pipe with no obstruction, the viscous resistance of a straight length of pipe with no obstruction, a reverse Venturi, or combinations thereof.

In an embodiment disclosed, the differential pressure sensors are miniaturized to be internalized within the in-line conduit and integrated within the differential pressure flow element.

In an embodiment disclosed, the multiphase fluid is a three phase fluid. In an embodiment disclosed, the multiphase fluid is oil, water, and gas. In an embodiment disclosed, the multiphase fluid is gas, gas condensate and water. In an embodiment disclosed, the multiphase fluid is any three distinct fluids.

In a further aspect, the present disclosure provides a method of measuring a flow parameter of a multiphase fluid in a flow conduit, including measuring pressure differentials, dp₁, dp₂, and dp₃ across three differential pressure flow elements disposed in the conduit, two at locations near the extremities of a uniform flow pipe, and the third across the other two, and determining the flow parameter of the multiphase fluid from the pressure differentials, dp₁, dp₂, and dp₃.

In an embodiment disclosed, the method further includes measuring the pressure P and the temperature T of the multiphase fluid in the flow conduit, and determining the flow parameter of the multiphase fluid from the pressure differentials, dp₁, dp₂, and dp₃ and the pressure P and the temperature T.

In a further aspect, the present disclosure provides computer-readable medium having computer-readable code embodied therein, the computer-readable code executable by a processor of a computer to implement the methods disclosed herein.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a diagrammatic view of the multiphase mass flowmeter with 2 orifice obstructions and 3 pressure differentials;

FIG. 2 is a diagrammatic view of the multiphase mass flowmeter with 2 Venturi obstructions and 3 pressure differentials;

FIG. 3 is a diagrammatic view of the multiphase mass flowmeter with a Venturi obstruction and an orifice obstruction and 3 pressure differentials;

FIG. 4 is a diagrammatic view of the multiphase mass flowmeter with two reverse Venturi obstructions and 3 pressure differentials where the flow elements (obstructions) and the sensors are located inside the pipe;

FIG. 5 is a diagrammatic view of the multiphase mass flowmeter with an orifice obstruction a vertical length of pipe, a horizontal length of pipe and 3 pressure differentials; and

FIG. 6 is a diagrammatic view of the multiphase mass flowmeter with a Venturi obstruction, a vertical length of pipe, a horizontal length of pipe and 3 pressure differentials.

### DETAILED DESCRIPTION

Generally, the present disclosure provides a method and apparatus determining multiphase fluid flow parameters.

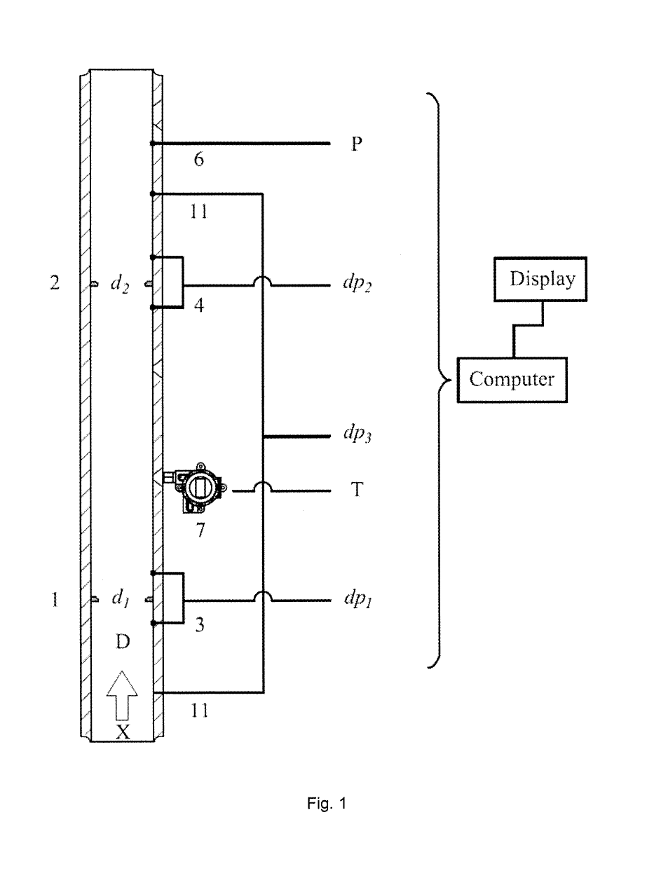

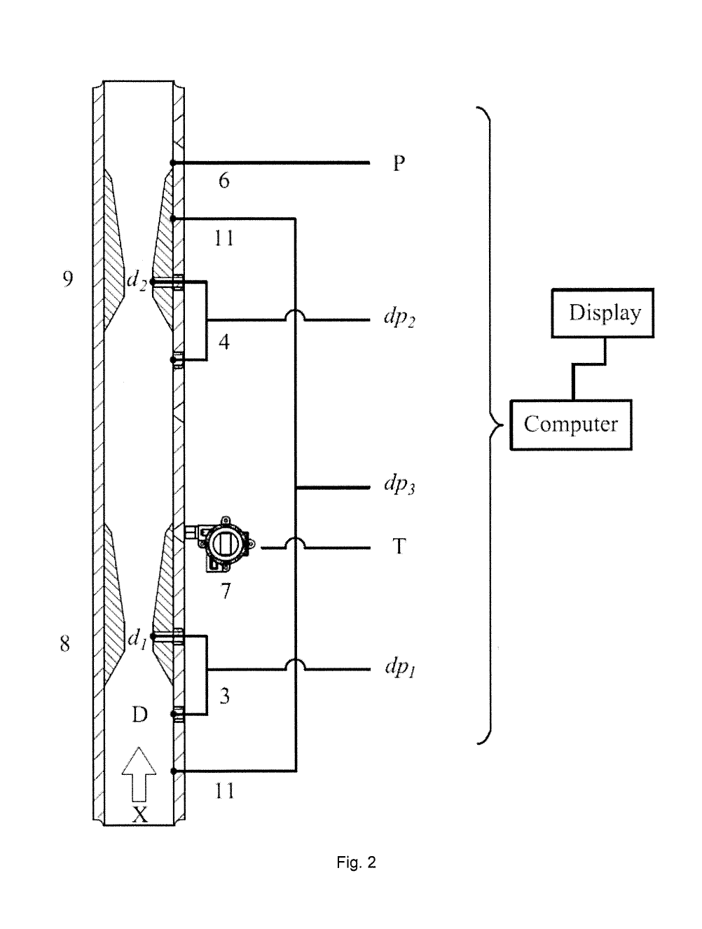

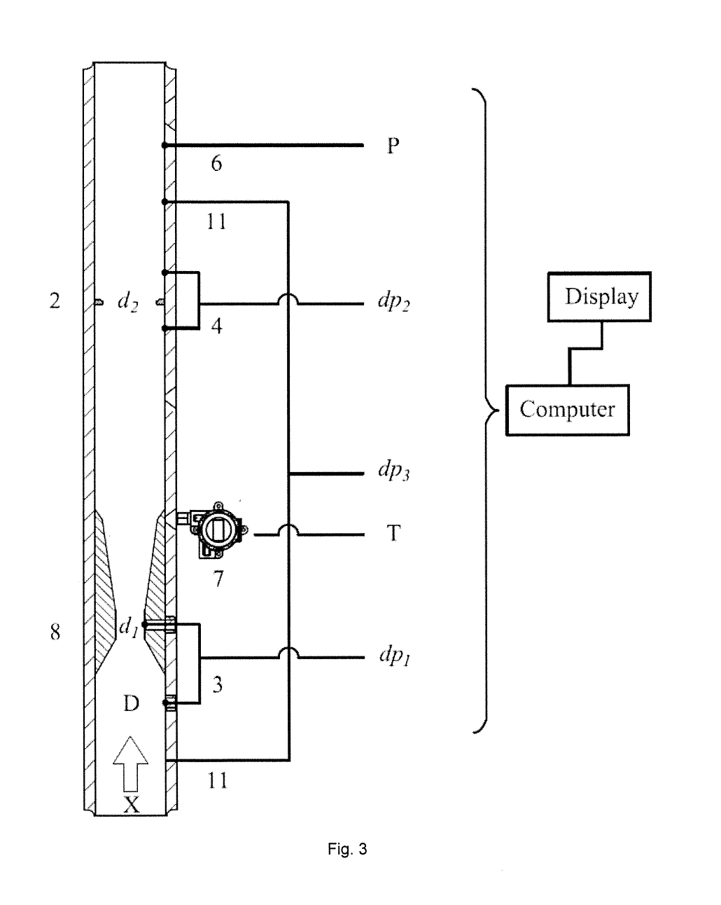

Referring to the FIGS. 1-6, the following reference are used:
1 is the upstream orifice obstruction
2 is the downstream orifice obstruction
3 is the upstream first differential pressure sensor
4 is the downstream second differential pressure sensor
6 is the pressure sensor
7 is the temperature sensor
8 is the upstream Venturi obstruction
9 is the downstream Venturi obstruction
10 is the length of pipe without obstruction
11 is the third differential pressure sensor
12 is the internal reverse Venturi (obstruction)
D is the inner diameter of the uniform pipe
d₁ is the inner diameter of the upstream obstruction
d₂ is the inner diameter of the downstream obstruction
X is the direction of flow

The following parameters are defined for use in the equations that follow in this description:

c_{d1}=flowrate coefficients of the first upstream flow element

c_{d2}=flowrate coefficients of the second downstream flow element

c_{d3}=flowrate coefficients of third flow element

D=pipe inner diameter

d₁=inner diameter of the obstruction at the first upstream flow element 1 (if the flow element is without obstruction then d₁=D)

d₂=inner diameter of the obstruction at the second downstream flow element (if the flow element is without obstruction then d₂=D)

d₃=inner diameter of the obstruction at the third flow element (if the flow element is without obstruction then d₃=D)

dp₁=pressure differential at first upstream flow element

dp₂=pressure differential at second downstream flow element

dp₃=pressure differential at third flow element

n₁=gas liquid ratio (GLR)

Q_{L1}=flowrate of liquid

Qₘ₁=mass flowrate at first upstream flow element

Qₘ₂=mass flowrate at second downstream flow element

Q₁=volumetric flowrates at first upstream flow element

Q₂=volumetric flowrates at second downstream flow element

Q_{g}=gas phase volumetric flowrates

Q_{w}=water phase volumetric flowrates

Qₒ=oil phase volumetric flowrates

P=pressure

T=temperature

ρ_{L+g}=density of total mixture, liquid+gas, at pipe flowing conditions

ρ_{L}=density of liquid

ρ_{g}=density of gas at pipe flowing conditions

WR=water cut

GVF=Gas Volume Fraction

Referring to FIGS. 1-6, all are characterized by a flow pipe of diameter D. Along the direction of the flow, as indicated by the arrow X, flow elements are installed in sequence. The flow elements are located at defined locations where a pressure differential is caused, either by an obstruction (i.e. orifice, Venturi, etc.) or by either gravity or drag in length of pipe without obstruction. The present disclosure utilizes three flow elements in sequence. The first obstruction, located upstream, and the second obstruction, located downstream have inner diameters d₁ and d₂ respectively. At arbitrary locations along the length of the pipe, a pressure P transmitter 6 and a temperature T transmitter 7 are installed.

When multiphase flow passes through the flow elements in sequence along the direction X, a pressure drop takes place at the first obstruction due to the localized constraining of the flow area. This pressure drop dp₁ is measured by the differential pressure transmitter 3. Similarly, at the second obstruction, the pressure drop dp₂ takes place and is measured by the differential pressure transmitter 4. In between these two points, the pressure transmitter 6 measures the pressure P and the temperature transmitter 7 measures the temperature T. This disclosure and its method for analyzing multiphase flow and for measuring the individual flowrates for the phases (oil, water and gas) makes use of the above parameters, which are measured directly.

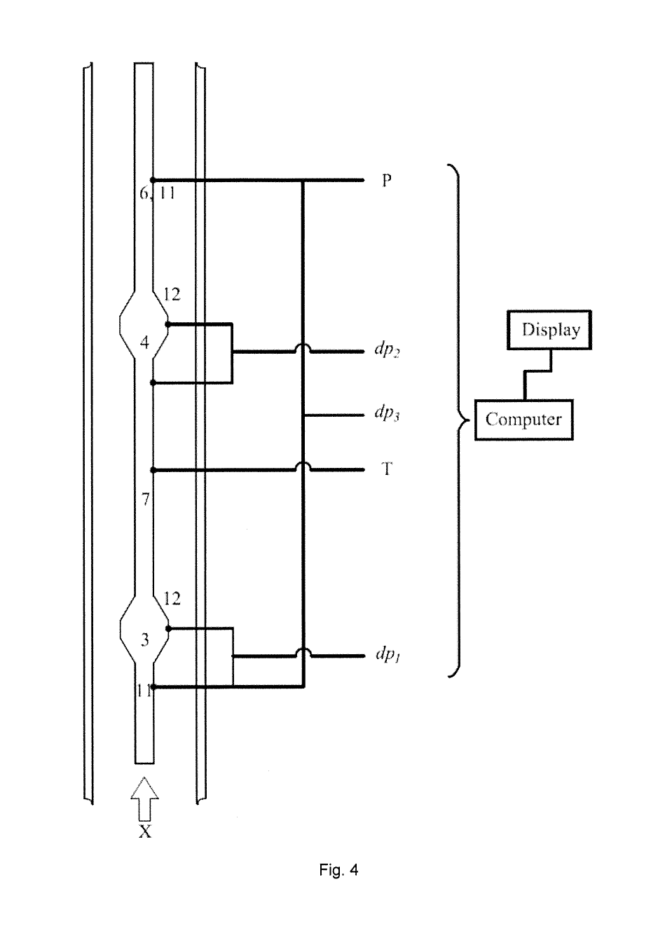

The third pressure differential dp₃ can be obtained in a variety of ways. The preferred ways are illustrated in FIGS. 1-6. This third differential dp₃ can be measured across the length of the 2 other flow elements in sequence (FIGS. 1-3), or alternatively it is measured across the length of a pipe without obstruction (FIGS. 4-6). When two such flow element are in sequence, the preferred configuration is for one length to be vertical and the other horizontal. In this arrangement, the second flow element, responsible for producing the pressure differential dp₂ is the horizontal length, while the vertical length is responsible for producing the differential dp₃.

At the first and at the second flow element respectively, the mass flowrate of the total mixture is obtained as follows:

Qₘ₁=c_{d1}\sqrt{k₁ρ_{L+g1}dp₁} and Qₘ₂=c_{d2}\sqrt{k₂ρ_{L+g2}dp₂} (1)

and:

$$\begin{matrix}k = \frac{{d}^{4}}{1 - {( \frac{d}{D} )}^{4}} \times \frac{π}{4} \sqrt{2} for an orifice obstrucion ; & ( 2 ) \\ k = \frac{{d}^{4}}{1 - {( \frac{d}{D} )}^{4}} \times \frac{π}{4} \sqrt{2} for a venturi obstuction ; or & \\ k = 1 for a length of pipe without obstruction . & \end{matrix}$$

The flowrate coefficient c_{d} varies for different types of obstructions, and is dependent the ratio of obstruction diameter to pipe diameter (d/D) ratio and Reynolds number. For an orifice obstruction, it is approximately 0.6. For Venturi obstruction, it is between 0.92˜0.99, with 0.975 as a standard. For a length of pipe without obstruction it is 1.

From the principle of mass flowrate conservation, it is determined that:

Qₘ₁=Qₘ₂

Applying equation (1) to the above, one can obtain a ratio G as follows:

$$\begin{matrix}G = \frac{{k}_{2} {dp}_{2}}{{k}_{1} {dp}_{1}} = \frac{{ρ}_{L + g 1}}{{ρ}_{L + g 2}} = \frac{{Q}_{2}}{{Q}_{1}} & ( 3 ) \\ where \text{:} & \\ {Q}_{1} = \frac{{Q}_{m 1}}{{ρ}_{L + g 1}} & \\ and \text{:} & \\ {Q}_{2} = \frac{{Q}_{m 2}}{{ρ}_{L + g 2}} & \end{matrix}$$

Here using subscripts o, w and g to represent oil, water and gas, then:

Q₁=Qₒ₁+Q_{w1}+Q_{g1}

Q₂=Qₒ₂+Q_{w2}+Q_{g2} (4)

The individual volumetric flowrates of oil, water and gas composing the overall multiphase flow will, in the first and in the second flow elements respectively, satisfy the following linear relationships:

Qₒ₂=aQₒ₁

Q_{w2}=bQ_{w1}

Q_{g2}=cQ_{g1}

Where a, b and c are the coefficients of linearity for each phase relating the volumetric flowrates in the first flow element to the volumetric flowrates in the second flow element. From Equation (4) it is determined:

$$G = \frac{{k}_{2} {dp}_{2}}{{k}_{1} {dp}_{1}} = \frac{{aQ}_{o 1} + {bQ}_{w 1} + {cQ}_{g 1}}{{Q}_{o 1} + {Q}_{w 1} + {Q}_{g 1}} \qquad ( 5 )$$

After the multiphase flow passes the first flow element, the watercut WR₁ and the gas liquid ratio (GLR) defined as n₁ are:

$${WR}_{1} = \frac{{Q}_{w 1}}{{Q}_{o 1} + {Q}_{w 1}} \\ {n}_{1} = \frac{{Q}_{g 1}}{{Q}_{o 1} + {Q}_{w 1}} \qquad ( 6 )$$

From Equation (5):

$$G = \frac{{k}_{2} {dp}_{2}}{{k}_{1} {dp}_{1}} = \frac{a ( 1 - {WR}_{1} ) + {bWR}_{1} + {cn}_{1}}{1 + {n}_{1}} \qquad ( 7 )$$

The coefficients a, b and c can be determined by the values of G at pure oil, pure water and pure gas phase states:

a=G|_{pure oil} b=G|_{pure water} c=G|_{pure gas} (8)

In an embodiment of the present disclosure, three flow elements are in sequence without an Ultrasound Doppler sensor. Such configuration may be achieved a variety of ways, including for example, as shown in FIGS. 1-6.

The third flow element is always vertical and causes a pressure differential dp₃ to be measured. Let dp₃* represents the total pressure drop across the length of the vertical pipe.

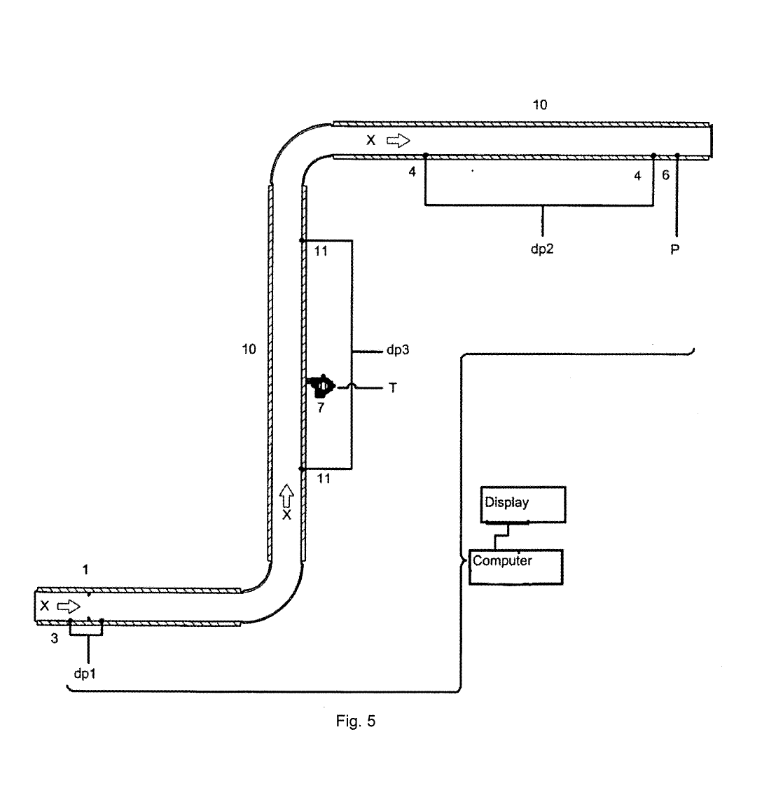

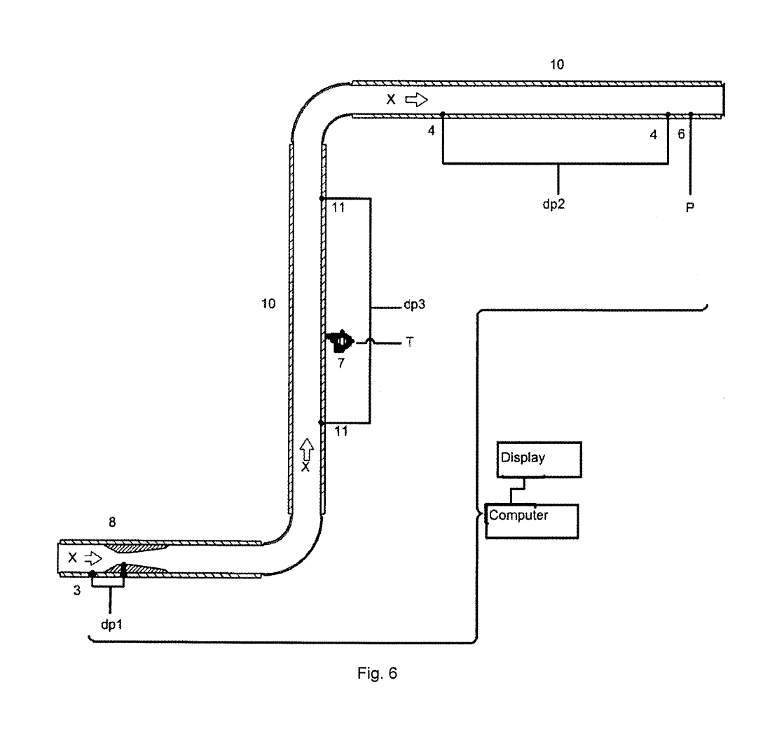

If the third flow element is without an obstruction (FIGS. 5 and 6), then:

dp₃*=dp₃ (9)

If dp₃ is measured across two other flow elements within the vertical pipe (FIGS. 1-4), then the obstructions of the third flow element can be treated as a step orifice or step Venturi, thus:

dp₃*=dp₃−dp₂−dp₁ (10)

At the first and second flow element, the mass flowrate of the total mixture is obtained in Equations (1) and (2).

Here we name k₁*=c_{d1}\sqrt{k₁} which includes both the effects of obstruction geometry and flowrate coefficient. Thus the total mass flowrate at the first flow element can be simplified as:

Qₘ₁=k₁*·\sqrt{dp₁·ρ_{L+g1}} (11)

The total volumetric flowrate at the first flow element is:

$${Q}_{1} = \frac{{Q}_{m 1}}{{ρ}_{L + g 1}} \qquad ( 12 )$$

At the third flow element, the mass flowrate of the total mixture is as follows:

Qₘ₃=k₃·dp₃*·ρ_{L+g3} (13)

where:

$${k}_{3} = \frac{{π ( \frac{D}{2} )}^{4}}{8 {η}_{l} L} \qquad ( 14 )$$

where η_{L} is the apparent viscosity of the mixture fluid, L is the straight length of pipe dp₃* is measuring.

From the principle of mass flowrate conservation:

Qₘ₁=Qₘ₃ (15)

And considering in the same pipe, where the third flow elements is in close proximity of the first flow element:

ρ_{L+g1}=ρ_{L+g3}=ρ_{L+g} (16)

From Equations (1) and (11), one obtains:

$${k}_{1}^{{*}^{2}} \frac{{dp}_{1}}{{ρ}_{L + g}} = {k}_{3}^{2} {dp}_{3}^{*} \\ {ρ}_{L + g} = {ρ}_{L + g 1} = {( \frac{{k}_{1}^{*}}{{k}_{3}} )}^{2} \frac{{dp}_{1}}{{dp}_{3}^{*}} \qquad ( 17 )$$

We know that Gas Volume Fraction GVF can be expressed by densities of total mixture, liquid and gas at pipe flowing conditions. GVF can also be expressed by volumetric flowrates of liquid and gas as follows:

$$G V F = \frac{{ρ}_{L + g 1} - {ρ}_{g}}{{ρ}_{L 1} - {ρ}_{g}} = \frac{{Q}_{g 1}}{{Q}_{g 1} + {Q}_{o 1} + {Q}_{w 1}} \qquad ( 18 )$$

From above equation (6):

$${n}_{1} = \frac{{Q}_{g 1}}{{Q}_{o 1} + {Q}_{w 1}} = \frac{G V F}{1 - G V R} = \frac{{ρ}_{L + g 1} - {ρ}_{g}}{{ρ}_{L 1} - {ρ}_{L + g 1}} \qquad ( 19 )$$

It is also known that liquid density and Watercut WR has the following relationship:

ρ_{L1}=WR₁ρ_{w}+(1−WR₁)ρₒ

The Gas Liquid Ratio n₁ can then be further expressed as:

$${n}_{1} = \frac{{ρ}_{L + g 1} - {ρ}_{g}}{{WR}_{1} ( {ρ}_{w} - {ρ}_{o} ) + {ρ}_{o} - {ρ}_{L + g 1}} \qquad ( 20 )$$

From above equation (7):

$$\begin{matrix}G = \frac{a ( 1 - {WR}_{1} ) + {bWR}_{1} + c \frac{{ρ}_{m} - {ρ}_{g}}{{WR}_{1} ( {ρ}_{w} - {ρ}_{o} ) + {ρ}_{o} - {ρ}_{m}}}{1 + \frac{{ρ}_{m} - {ρ}_{g}}{{WR}_{1} ( {ρ}_{w} - {ρ}_{o} ) + {ρ}_{o} - {ρ}_{m}}} \\ = \frac{[ {WR}_{1} ( {ρ}_{w} - {ρ}_{o} ) + {ρ}_{o} - {ρ}_{m} ] [ ( b - a ) {WR}_{1} + a ] + c ( {ρ}_{m} - {ρ}_{g} )}{{WR}_{1} ( {ρ}_{w} - {ρ}_{o} ) + {ρ}_{o} - {ρ}_{g}} \\ = \frac{[ {WR}_{1} ( {ρ}_{w} - {ρ}_{o} ) + {ρ}_{o} - {ρ}_{m} ] [ ( b - a ) {WR}_{1} + a ] + c ( {ρ}_{m} - {ρ}_{g} )}{{WR}_{1} ( {ρ}_{w} - {ρ}_{o} ) + {ρ}_{o} - {ρ}_{g}}\end{matrix} \qquad ( 21 )$$

By expanding all the terms into a quadratic equation with Watercut WR as the only unknown, one obtains:

WR₁²(b−a)(ρ_{w}−ρₒ)

+WR₁[b(ρₒ−ρₘ)+a(ρₘ+ρ_{w}−2ρₒ)+G(ρₒ−ρ_{w})]

+a(ρₒ−ρₘ)+c(ρₘ−ρ_{g})+G(ρ_{g}−ρₒ)=0 (22)

To simplify the quadratic equation, we name three parameters A, B and C as follows:

A=(b−a)(ρ_{w}−ρₒ)

B=b(ρₒ−ρₘ)+a(ρₘ+ρ_{w}−2ρₒ)+G(ρₒ−ρ_{w})

c=a(ρₒ−ρₘ)+c(ρₘ−ρ_{g})+G(ρ_{g}−ρₒ) (23)

Then Watercut WR can be resolved from equation:

$$A \cdot {WR}_{1}^{2} + B \cdot {WR}_{1} + C = 0 \\ {WR}_{1} = \frac{- B + \sqrt{{B}^{2} - 4 A C}}{2 A} \qquad ( 24 )$$

Finally, after obtaining Watercut WR₁ and the Gas Liquid Ratio n₁ from Equation (20), the volumetric flowrates of gas, total liquids, water and oil phases can be expressed as:

$${Q}_{g 1} = \frac{1}{1 + {n}_{1}} {Q}_{1} \\ {Q}_{l 1} = \frac{{n}_{1}}{1 + {n}_{1}} {Q}_{1} \\ {Q}_{o 1} = {WR}_{1} {Q}_{L 1} \\ {Q}_{w 1} = ( 1 - {WR}_{1} ) {Q}_{L 1} \qquad ( 25 )$$

In summary, the logical sequence of the present is disclosure describes a route to obtain multiphase measurements of oil, water and gas. In applying the method described in the present disclosure, a microcomputer with embedded algorithms processes the pressure differential readings from the pressure differential transmitters for all embodiments as described in FIGS. 1 to 6.

### Example

As an example, a 2″ meter with the following meter dimensions:
d₁=21.6 mm; d₂=19.6 mm; and D=52.48 mm

The discharge coefficient of an orifice 1 is c_{d1}=0.6.

Referring to FIG. 1, for example, three differential pressures, dp₁, dp₂, and dp₃ are measured:

dp₁=30 kPa

dp₂=45 kPa

dp₃=85 kPa

As well, pressure P and temperature T are measured:

P=1,000 kPa

T=15.6° C.

The densities of each single phase are known, in this example oil, gas, and water:

ρ₀=850 kg/m³

ρ_{g}=10 kg/m³

ρ_{w}=1,000 kg/m³

From Equation 7 above and the method of Equation 8, the following parameters are obtained through experiments:

a=G|_{pure oil}=1.003

b=G|_{pure water}=1.017

c=G|_{pure gas}=0.9994

Using these readings, parameters and known densities, the present disclosure provides a method of obtaining flow data, including phase ratios and individual phase volumetric flowrates as follows:

$${Q}_{m 1} = {k}_{1}^{*} \cdot \sqrt{{dp}_{1} \cdot {ρ}_{L + g 1}} = 1.1235 kg \text{/} s$$

$${ρ}_{L + g} = {ρ}_{L + g 1} = {( \frac{{k}_{1}^{*}}{{k}_{3}} )}^{2} \frac{{dp}_{1}}{{dp}_{3}^{*}} = 467.5 \frac{kg}{{m}^{3}}$$

$${Q}_{1} = \frac{{Q}_{m 1}}{{ρ}_{L + g 1}} = 2.403 \times {10}^{- 3} \frac{{m}^{3}}{s}$$

$${WR}_{1} = 0.75$$

$${n}_{1} = 0.92424$$

$${Q}_{g 1} = \frac{1}{1 + {n}_{1}} {Q}_{1} = 1.249 \times {10}^{- 3} {am}^{3} \text{/} s under flowline conditions . \\ {Q}_{g 1} = 1.233 \times {10}^{- 2} {sm}^{3} \text{/} s = 37.621 MSCFD under standard conditions . \\ {Q}_{l 1} = \frac{{n}_{1}}{1 + {n}_{1}} {Q}_{1} = 1.154 \times {10}^{- 3} {m}^{3} \text{/} s = 627.24 BPD . \\ {Q}_{w 1} = {WR}_{1} {Q}_{L 1} = 470.43 BPD$$

$${Q}_{o 1} = ( 1 - {WR}_{1} ) {Q}_{L 1} = 156.81 BPD$$

In an embodiment disclosed, the microcomputer utilizes the analytical route described in obtaining multiphase measurements of oil, water, and gas and provides an output to a display or provides an output to a recorder or other control system or combinations thereof.

It is important to note that all embodiments include readings of the pressure P and temperature T from transmitters 6 and 7. These signals enable the conversion of the above described individual phase flowrates, which are measured at any pressure or temperature condition of the pipe, into a standard atmospheric value.

The parameters thus computed by the disclosure include:

Flow pressure

Flow temperature

Pressure differential across the device

Actual oil flowrate

Standard oil flowrate

Actual water flowrate

Actual water cut

Standard water cut

Actual gas flowrate

Standard gas flowrate

Mix density

Mix velocity

Actual gas volume fraction

Standard gas volume fraction

Standard gas oil ratio

Accumulated oil volume in actual condition

Accumulated oil volume in standard condition

Accumulated water volume in actual condition

Accumulated water volume in standard condition

Accumulated gas volume in actual condition

Accumulated gas volume in standard condition

It is evident that components of the body of the flowmeter could be disposed in a variety of configurations without departing from the scope of the disclosure. Although all flowmeters are shown as a compact structure with means of creating and measuring pressure differentials in a single conduit, it will be appreciated by persons skilled in the art that the components can be disposed in different orders or widely spaced with respect to each other.

The device is self-sufficient in the sense that it analyses and measures multiphase flow without requiring other devices to be installed upstream or downstream in order to measure water cut or perform other two-phase in well measurements. It measures directly pure phase flow rates without the need using PVT information or conversion factors. It does not need other upstream devices to perform fluid separation or fluid conditioning. The system is compact and easily installed on any single conduit at any point immediately downstream of the well head.

In the preceding description, for purposes of explanation, numerous details are set forth in order to provide a thorough understanding of the embodiments. However, it will be apparent to one skilled in the art that these specific details are not required. In other instances, well-known electrical structures and components are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A multiphase flowmeter for measuring the flow of a multiphase fluid through an in-line conduit comprising:
three differential pressure flow elements disposed in the conduit, two at locations near the extremities of a uniform flow pipe, and the third across the other two, where three pressure differentials dp₁, dp₂, and dp₃ are measured with three differential pressure sensors;
a pressure P sensor; and
a temperature T sensor.

2. The multiphase flowmeter of claim 1, further comprising a flow computer for computing one or more flow parameters of the multiphase fluid from pressure differentials dp₁, dp₂, dp₃, and pressure P and temperature T sensors.

3. The multiphase flowmeter of claim 1, wherein the three pressure differentials dp₁, dp₂, dp₃, the pressure P sensor, and the temperature T sensor are disposed over a plurality of tubular members or in different order or locations.

4. The multiphase flowmeter of claim 1, wherein the differential pressure flow elements are selected from the group including but not limited to: an orifice plate, a Venturi, the friction resistance of a straight length of pipe with no obstruction, the viscous resistance of a straight length of pipe with no obstruction, a reverse Venturi, or combinations thereof.

5. The multiphase flowmeter of claim 1 wherein the differential pressure sensors are miniaturized to be internalized within the in-line conduit and integrated within the differential pressure flow element.

6. The multiphase flowmeter of claim 1, wherein the multiphase fluid is selected from the group consisting of:
a three phase fluid;
oil, water, and gas;
gas, gas condensate and water; and
any three distinct fluids.

7. A method of measuring a flow parameter of a multiphase fluid in a flow conduit, comprising:
measuring pressure differentials, dp₁, dp₂, and dp₃ across three differential pressure flow elements disposed in the conduit, two at locations near the extremities of a uniform flow pipe, and the third across the other two; and
determining the flow parameter of the multiphase fluid from the pressure differentials, dp₁, dp₂, and dp₃.

8. The method of claim 7, further comprising measuring the pressure P and the temperature T of the multiphase fluid in the flow conduit; and
determining the flow parameter of the multiphase fluid from the pressure differentials, dp₁, dp₂, and dp₃ and the pressure P and the temperature T.

9. A computer-readable medium having computer-readable code embodied therein, the computer-readable code executable by a processor of a computer to implement the method according to claim 7.
